(19) United States
(12) Patent Application Publication
(10) Pub. No.: US 2009/0248226 A1
(43) Pub. Date: Oct. 1, 2009

(54) System and Method for Verifying a Distributed Power Train Setup

(76) Inventors: Steven Andrew Kellner, West Melbourne, FL (US); Bret Dwayne Worden, Union City, PA (US); Scott Zarella, Erie, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/054,537

(22) Filed: Mar. 25, 2008

(51) Int. Cl. G06F 17/00; B61L 23/00; H04B 7/185

(52) U.S. Cl. 701/19; 246/167 R; 342/357.06

(57) ABSTRACT

A communication system for a distributed power control system of a train is used to transmit signals between the lead locomotive and remote locomotive relative to the direction of movement of the lead and remote units. In addition, data relative to the direction the remote unit is facing relative to the lead locomotive is also sent via the communication system. A controller is programmed to analyze or compare the data to determine if the remote locomotive is traveling in a direction that is consistent with the setup data input by an operator. If the information is not consistent, the operator of the train is warned via an alarm or the train is stopped.

### BACKGROUND OF THE INVENTION

Embodiments of the present invention relate to distributed power train systems, and, more particularly, to systems and methods for setting up and linking distributed power systems for a locomotives and a train consist.

Freight trains often include railcars linked together and stretching up to one or two miles long. Multiple locomotives are dispersed along the line of cars to power and operate the trains. The locomotives include a lead locomotive consist at the front of the train, and one or more remote locomotive consists distributed along the train and separated from the lead locomotive consist by multiple railcars. A “consist” is a group of locomotives that are physically and electrically connected together. An operator, usually located in the lead locomotive, controls operation functions of the remote locomotives via a distributed power control system. The distributed power control systems include a plurality of radio frequency (RF) modules mounted on respective lead and remote locomotives. Alternatively, the lead and remote locomotives might communicate via a wire that runs the length of the train. A protocol of command and status messages is communicated between the lead and remote locomotives via the communication modules or wired system to control operation of the locomotives and train.

The communication between the multiple locomotives operating in distributed power is linked or set up manually at a rail yard. One or more operators physically enter each locomotive to enter data or messages associated with the direction the remote locomotives are facing, and/or the direction of travel of the remote units relative to the lead locomotive. At the lead locomotive, an operator typically enters the remote locomotive road number. At the remote locomotive, an operator enters the lead locomotive road number to which the remote will be linked and the direction in which the remote locomotive is facing and/or will be traveling relative to the lead locomotive. For example, the lead locomotive is typically facing with its short hood traveling in a forward direction as depicted in FIG. 1. If the remote locomotive is facing in the same direction as the lead, the operator enters an input for “same”; or, if the locomotive is facing in the opposite direction of that of the lead locomotive, the operator enters an input for “opposite.”

In as much as a train may be as long as one to two miles, an operator cannot see the lead locomotive or the direction in which the lead locomotive is facing during setup. In order to verify that the distributed power control system is setup properly, with all the locomotives set up to motor in the same direction, the operator may literally drive from locomotive to locomotive to double check the setup. Another method of verifying a proper communication link includes independently throttling up the remote locomotives to assure that all the locomotives are motoring in the same direction. Despite these efforts the setup remains subject to human error, and can be time consuming.

In cases when one or more of the remote locomotives is motoring in a direction opposite to that of the lead locomotive, the train may break apart in the rail yard when the locomotives begin throttling up, in which case the train will go into an emergency brake application. Other times, the remote locomotives may over power the lead locomotive, the operator in the lead locomotive will realize the lead locomotive is not traveling in the correct direction and then stop the train. However, typically the lead locomotive or locomotives will over power the remote locomotives and the train may travel for miles before an error in the distributed power control system setup is discovered. A remote locomotive motoring in a direction opposite to that of the lead locomotive can cause a train to break apart, a train derailment or otherwise cause damage to one or more of the locomotives. Accordingly, a need exist for a system and/or method for verifying that a distributed power control system for a train having a lead locomotive and one or more remote locomotives has been properly set up so that the remote locomotives are traveling or motoring in the same direction as the lead locomotive.

### BRIEF DESCRIPTION OF THE INVENTION

A system for verifying the set up of a distributed power control system having a lead locomotive, one or more remote locomotives and a plurality of railcars, includes a radio frequency or wire based communication system between the lead locomotive and the remote locomotive for a train. The system may include an input command mechanism for the distributed power control system enabling an operator to enter setup data indicative of a direction the remote locomotive is facing relative to the lead locomotive. In addition, the system may include at least one controller, linked to the communication system, for determining the direction of movement of the lead locomotive and the remote locomotive. After the train begins moving on a track the communications system provides a status signal from the remote locomotive to the lead locomotive, which signal is indicative of the direction of movement of the remote locomotive. In addition, the signal also transmits the remote setup data to the lead locomotive. The system is equipped with a controller wherein the controller compares data relative to the direction of movement of the lead locomotive to data relative to the direction of movement of the remote locomotive and to the remote locomotive setup data to verify whether the setup data has been properly entered.

### BRIEF DESCRIPTION OF THE DRAWINGS

FIG. 1 is an illustration of a locomotive showing a short hood forward direction of movement.

FIG. 2 is an illustration of a locomotive showing a long hood forward direction of movement.

FIG. 3 is a schematic illustration of a hardware configuration for operation of the present invention.

FIG. 4 is a schematic illustration of a train having a remote locomotive properly set up to travel in the same short hood forward direction as the lead locomotive.

FIG. 5 is a schematic illustration of a train having a remote locomotive properly set up to travel in a long hood forward, which is opposite of the lead, which is traveling short hood forward.

FIG. 6 is a schematic illustration of a train having a remote locomotive incorrectly set up as facing opposite to the direction of movement of the lead locomotive.

FIG. 7 is a schematic illustration of a train having a remote locomotive incorrectly set up as facing the same direction of movement of the lead locomotive.

FIG. 8 is a schematic illustration of a second embodiment of the invention where a remote locomotive is properly set up to travel in the same short hood forward direction as the lead locomotive.

FIG. 9 is a schematic illustration of the second embodiment of the invention where a remote locomotive is incorrectly set up as facing opposite to the direction of movement of the lead locomotive.

FIG. 10 is a flow chart listing the steps of an embodiment of a method for a distributed power train setup

### DETAILED DESCRIPTION OF THE INVENTION

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained.

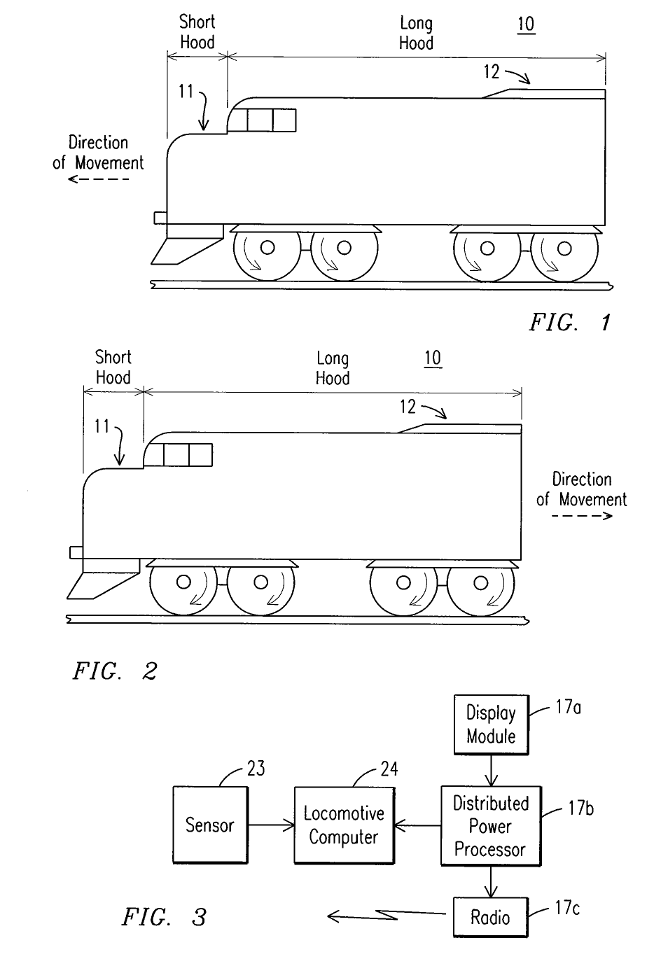

With respect to FIGS. 1 and 2, there is shown a locomotive 10 and terminology relevant to the direction of movement of a locomotive in a train. The locomotive 10 has a front portion 11 and a rear portion 12. The front portion 11 of the locomotive 10 is typically referred to as the “short hood”, and the remaining portion or rear portion 12 of the locomotive 10 is referred to as the “long hood”. Accordingly, with respect to FIG. 1, movement of a locomotive in the direction of the short hood 11 is referred to as “short hood forward”; and, with respect to FIG. 2, movement of the locomotive in direction of the long hood 12 is referred to as “long hood forward.”

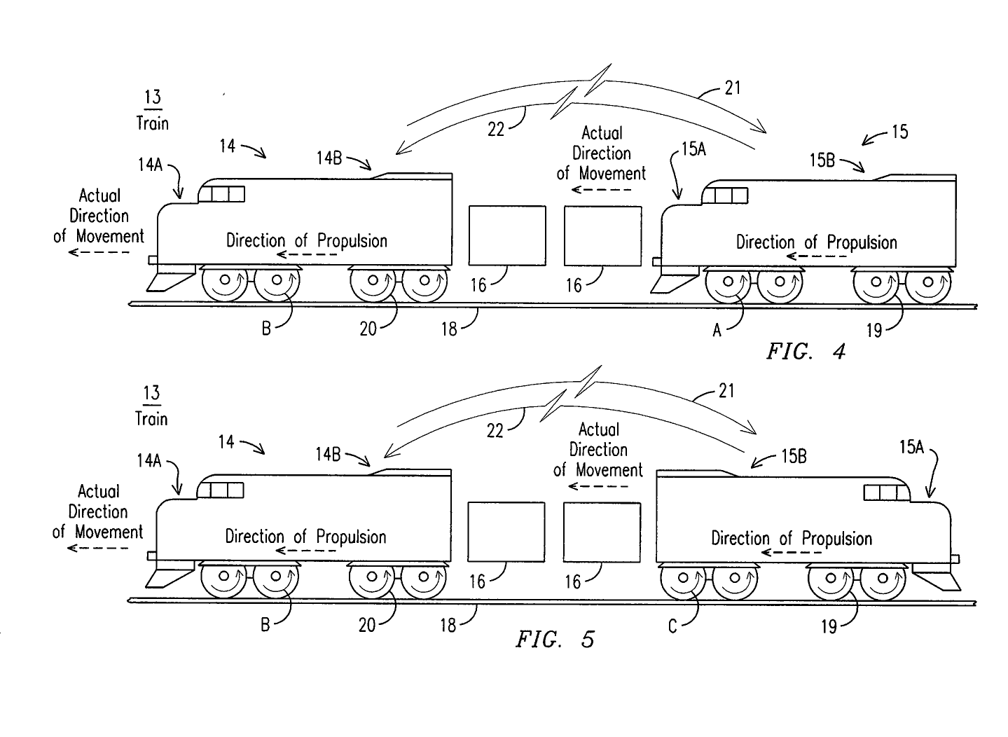

In FIGS. 4 and 5 there are illustrated two examples of a correct distributed power system setup for a train 13 having a lead locomotive 14 and a remote locomotive 15. In each of the locomotives 14 and 15 there is mounted a radio frequency communication module 17, which are components of a distributed power system for the train 13 for transmission and receipt of status messages, commands etc. between the locomotives 14 and 15. An example of such a distributed power system is the LOCOTROL® distributed power system manufactured by General Electric Transportation Rail. While embodiments of the invention described here may refer to a radio frequency communication system the invention is not so limited a may included wire-based communication systems.

A hardware configuration for a remote locomotive 15 is schematically illustrated in FIG. 3. More specifically, the radio frequency module 17 includes a display module 17A for inputting the locomotive setup data, a distributed power processor 17B for processing data for transmission of signals via the radio 17C, which may also receive signals. A locomotive computer/controller 24 is linked to a sensor 23 and the distributed power processor 17B. The sensor 23 monitors an operating parameter of a component of the remote locomotive 15 that is indicative of the direction of movement of the locomotive 15 and transmits signals to the controller 24, which also receives the locomotive setup data from the radio processor 17B.

As shown in these FIGS. 4 and 5, the two squares between the locomotives 14 and 15 schematically represent railcars 16 linked together and to the lead locomotive 14 and the remote locomotive 15. The train 13 is positioned on a railroad track 18 for traveling. While the illustrations in the referenced figures show only a single remote locomotive 14, the system and method disclosed herein may be used with multiple remote locomotives 14 and is not limited to the use of a single remote locomotive.

In the embodiment, illustrated in FIGS. 4 through 9, the system utilizes data relative to a direction of movement of the locomotives to determine if the remote locomotive 15 has been properly setup and linked to the lead locomotive 14. For embodiments of the present invention data relative to the rotational direction of the wheels 20 of the lead locomotive 14 and wheels 19 of the remote locomotive 15 may be used to represent the direction of the movement of the locomotives 14, 15. Sensors 23 on the lead locomotive 14 and the remote locomotive 15 monitor or detect the rotational direction of the wheels 19, 20. The sensors 23 send signals to the controller/processor 24 on respective locomotives 14 and 15, which signals are indicative of the rotational direction of the wheels 19, 20. Some locomotives utilize for example directional speed sensors that detect the rotation of traction motors to determine direction of rotation of wheels or direction of movement of a locomotive.

Alternatively, axle tachometers with bi-direction information may be used to detect direction of rotation of axles or back emf (electro-magnetic force) data of traction motors may be used to detect direction of rotation of axles. In the case of DC motors by, exciting the traction motor field, and determining the polarity of the armature voltage can provide an indication of the direction of wheel rotation. In the case of AC motors the phase relationship can provide this indication. Alternatively, plugging information (traction motors rotating in a direction opposite to the direction that the locomotive is trying to rotate the traction motors) can be used. This information can be obtained by monitoring the traction motor current levels and comparing the data with the expected current levels for the voltage and/or frequency applied to them. A fault condition can be determined based on the severity and the duration of the current mismatch.

Yet another form of information which may be used is detecting the magnitude and direction of traction motor power flow. For example, if the tractive effort produced is in the long hood direction, and the locomotive is moving in the short hood direction power flow will be from the wheels to the motors to the electrical bus where as if the tractive effort produced is in the short hood direction, the power flow will be from the electrical bus to the motors to the wheel. In yet another method the tractive effort/creep slope information, can be used to ascertain the direction of rotation of the wheels or direction of movement of a locomotive. In this case, the inherent wheel-rail adhesion is used. For example, the lead axles tend to produce less tractive effort for the same creep. Therefore if the locomotive axle 6 (axle at the long hood) is having much lower tractive effort compared to the axle 1 (axle at the short hood), then the locomotive is going in the long hood direction. In this method a slope of the tractive effort versus wheel position can be used to determine the direction of travel.

Alternatively, differences in wheel to rail adhesion between axles and traction motors as a result of the application of sand to the rail can be used to ascertain the direction of rotation of the wheels or direction of movement of a locomotive. In this technique, sand or any other friction modifier is applied in between the short hood and long hood. If the area of the locomotive near the long hood experiences the rail condition difference, then the locomotive is traveling in the short hood direction.

In another embodiment, GPS determined locomotive location information and compass information could be used in conjunction with a track profile data base to determine the direction of movement of the locomotive. This technique could be used for non moving locomotives also. For a non-moving train, GPS information received from both ends of the locomotive can be used with a track database to determine if the remote locomotive is facing in the proper direction relative to the lead locomotive.

The controller 24 may be a controller/processor that is integrated in the communication module 17 or an onboard controller/processor that is integrated with a locomotive computer system and linked to the communications module 17 and power distribution system. In addition, setup data relative to the direction the locomotives 14, 15 are facing relative to one another is stored in the controllers 24 during the power distribution setup as described below.

As shown in FIG. 4, the short hood 15A of the remote locomotive 15 is facing in the same orientation in the train as the short hood 14A of the lead locomotive 14. In order for the distributed power control system to be “set up” properly, an operator (not shown) will board the cab of the remote locomotive 15 and enter “SAME” on the display module 17A, and setup data for the SAME command is stored in a memory in the distributed power processor 17B accessible by controller 24 on the remote locomotive 15. The “SAME” input command indicates that the remote locomotive 15 is facing the same direction in the train as the lead locomotive 14 so the wheels 19 of the remote locomotive will have a rotational direction represented by arrows A, which is the same rotational direction represented by arrows B on wheels 20 of the lead locomotive 14.

When the operator on the lead locomotive 14 commands a direction of movement (forward or reverse) and a throttle handle position a signal 21 (message) is sent from the lead locomotive 14 to the remote locomotive 15, which signal is indicative of the required notch level and required rotational direction of the wheels 20 or the required direction of propulsion and movement of the train 13 and remote locomotive 15. The signal 21 is sent via the power distribution control system or communications system. In this example in FIG. 4, the lead locomotive 14 is moving in the direction of “short hood forward” as indicated by arrow B on wheels 20 and the direction of propulsion. Sensors 23 on the lead locomotive 14 detect rotational direction of the wheels 20 on the lead locomotive and transmit signals indicative of the rotational direction (arrow B) of the wheels 20 to the controller 24, and the signal 21 is transmitted to the remote locomotive 15.

The remote locomotive 15, upon receipt of the signal 21, sends a status message or signal 22 to the lead locomotive 15, which signal 22 is indicative of the locomotive “setup” (in this case—SAME) and the direction of rotation of the remote locomotive 14 wheels 20 or direction of movement of the remote locomotive 15. The signal 22 may also be characterized as the transmission of the setup data (SAME) and status data (rotational direction of the wheels). As shown in FIG. 4, the wheels 19 of the remote locomotive 15 are moving in the direction of “short hood forward”. Sensors 23 on the remote locomotive 15 transmit signals indicative of the rotational direction (arrow A) of the wheels 19 to the controller 24, and the signal 22 is transmitted to the lead locomotive 14.

The lead locomotive 14, upon receipt of the status signal/message 22 from the remote locomotive 15, compares the status data of the remote locomotive 15 to the remote locomotive 15 “setup” or the setup data. In addition, the lead locomotive 14 compares data relative to the rotational direction (arrow B) of the wheels or direction of propulsion of the lead locomotive 14 to the remote locomotive 15 status data. In this example, the remote locomotive 15 status message/signal or data is consistent with or matches the remote locomotive 15 setup data. That is the lead locomotive 14 is moving in a short hood forward direction and the remote locomotive 15 or the wheels 19 of the remote locomotive are moving in a “short hood forward” direction which matches or is consistent with a SAME setup. With this confirmation the lead locomotive 14 continues to travel on the railroad 18.

With respect to FIG. 5, there is illustrated another example of a remote locomotive 15 that has been correctly “set up”, and linked with the lead locomotive 14. In this example, the remote locomotive 15 is facing in a direction in the train that is opposite to the direction in which the lead locomotive 14 is facing. The rotational wheel direction (indicated by arrow C) of wheels 19 and direction of propulsion for the remote locomotive 15 is “long hood forward”. In order for the remote locomotive 15 to move in the same direction as the lead locomotive 14 the remote locomotive 15 must travel in reverse, or “long hood forward”. Accordingly, during the set up procedure an operator enters data (the “setup data”) representative of the orientation of the remote locomotive 15 relative to the lead locomotive 14, which is OPPOSITE. When the lead locomotive 14 begins to travel forward on the railroad the above-described procedure is followed to confirm that the remote locomotive 15 and power control distribution control system has been properly setup. The signal 22 transmitted includes the setup data, which is OPPOSITE, and the status data, which is wheels 19 are rotating in a “long hood forward” direction. The lead locomotive 14 compares data relative to the direction of propulsion of the lead locomotive and remote locomotive 15 setup data to the remote locomotive 15 status data to confirm that the remote locomotive 15 has been properly setup. In this case, the lead locomotive 14 is moving in a short hood forward direction and the remote locomotive 15 is moving in a long hood forward direction which matches or is consistent with an OPPOSITE setup.

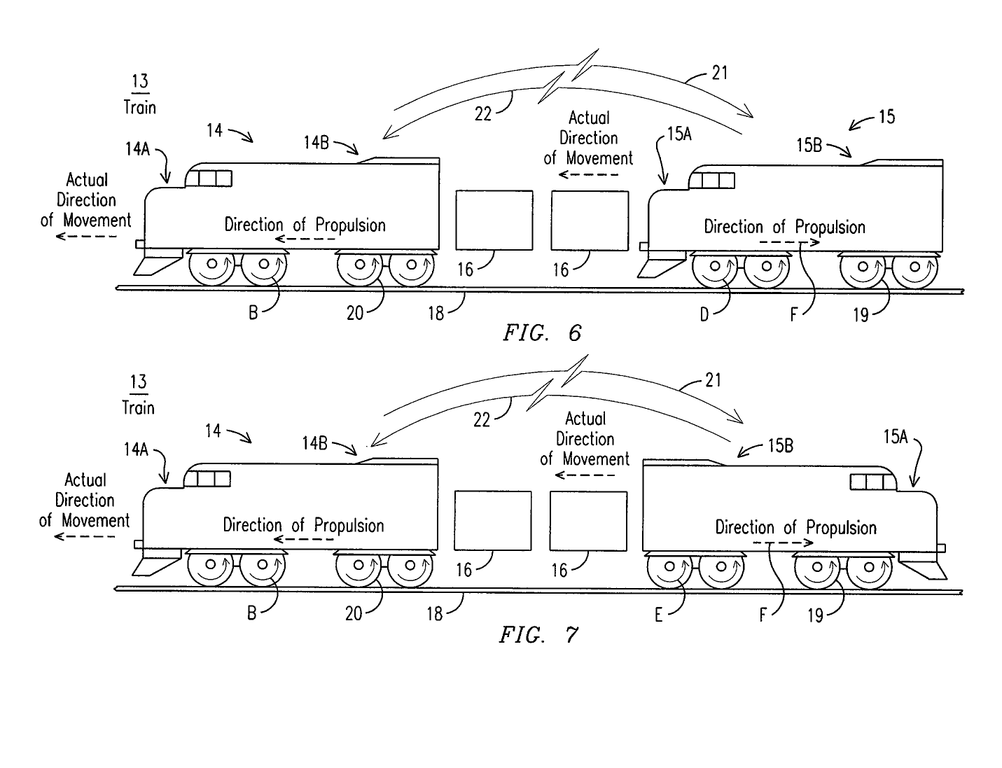

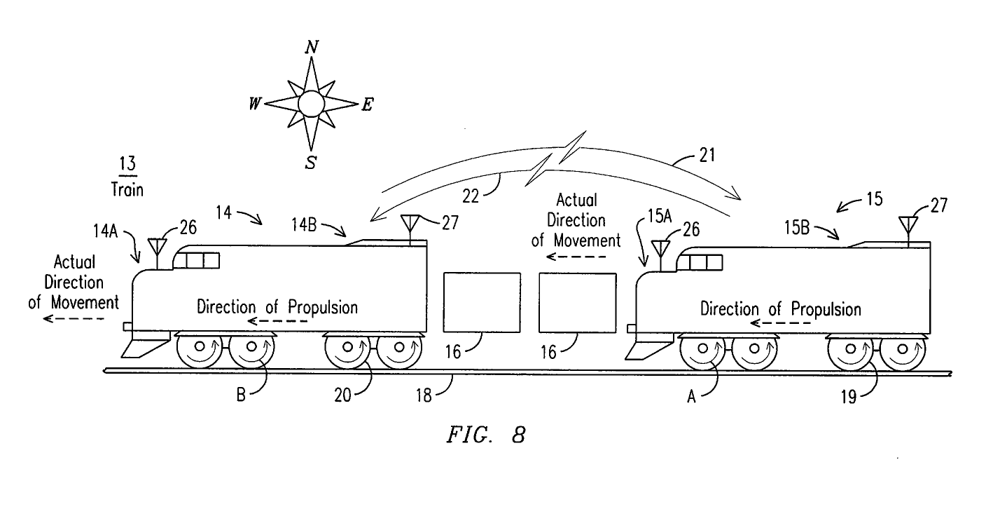

In FIGS. 6 and 7 there are illustrated examples of remote locomotives 15 having been incorrectly set up in the power distribution system. With respect to FIG. 6, the remote locomotive 15 is facing in the same direction, or short hood forward direction, as the lead locomotive 14. However, an operator has entered OPPOSITE setup data or long hood forward. That is the direction of propulsion (arrow F) is in the long hood forward direction. When the lead locomotive 14 begins to move forward in most cases it will overpower the remote locomotive 15 and the wheels 19 on the remote locomotive 15 will rotate in the short hood forward direction as indicated by arrow D on wheels 19.

The sensors 23 generate a signal indicative of the rotational direction (indicated by letter D) of the wheels 19 on the remote locomotive 15. In this case the wheels 19 are rotating in a short hood forward direction; however, the operator entered OPPOSITE, so the wheels 19 should be rotating in the long hood forward direction, or opposite direction. A status signal 22 is sent from the remote locomotive 15 to the lead locomotive 14, which signal 22 is indicative of the rotational direction (or direction of movement of the locomotive) of the wheels 19 and setup data of the remote locomotive 15. In this case the signal 22 indicates the wheels are moving short hood forward and the remote locomotive 15 is set up OPPOSITE (long hood forward).

The controller 24 on the lead locomotive 14 compares the status data of the lead locomotive 14 to the setup data entered by the operator to set up the remote locomotive 15 and the status data (direction of movement of locomotive or rotational direction of wheels 19) of the remote locomotive 15. In this case, the lead locomotive 14 is moving in a short hood forward direction and the remote locomotive 15 has been set up as OPPOSITE, which means the wheels 19 of remote locomotive 15 should be traveling in a long hood forward direction; however, the transmitted signal 22 indicates that the wheels 19 are rotating in a short hood forward direction. When the controller 24 determines there is an error, or the remote locomotive 15 setup data does not match the status data, an alarm may be generated so as to inform the operator on the lead locomotive 14 such that he can take the appropriate action as determined by railroad operating rules or such that the train can be automatically stopped. An operator can then enter the remote locomotive 15 and correct the setup error.

With respect to FIG. 7, remote locomotive 15 is facing a direction opposite to that of the lead locomotive 14, or in a long hood forward direction; however, an operator as entered the setup data as SAME, which is short hood forward. When an operator commands the lead locomotive 14 to move in the forward direction, a command/signal 21 is sent to the remote locomotive 15 instructing it to move in the forward direction as well. The remote locomotive 15 responds to this request by attempting to propel the short hood forward direction. When movement begins, the remote locomotive 15 transmits a status signal 22 which is indicative of the rotational direction (indicated by arrow E) of the wheels 19 or the direction of movement of the locomotive, and the remote locomotive 15 setup data. In this case, the lead locomotive 14 is moving in the short hood forward direction, and the remote locomotive 15 is moving in a long hood forward direction; however, the remote locomotive is set up as SAME, which means the direction of propulsion (arrow F) is opposite to that of the lead locomotive 14. When the controller 24 determines there is an error, or the remote locomotive 15 setup data does not match the status data, an alarm may be generated so as to inform the operator on the lead locomotive 14 and train 13 such that he can take the appropriate action as determined by railroad operating rules or such that the train can be automatically stopped. An operator can then enter the remote locomotive 15 and correct the setup error.

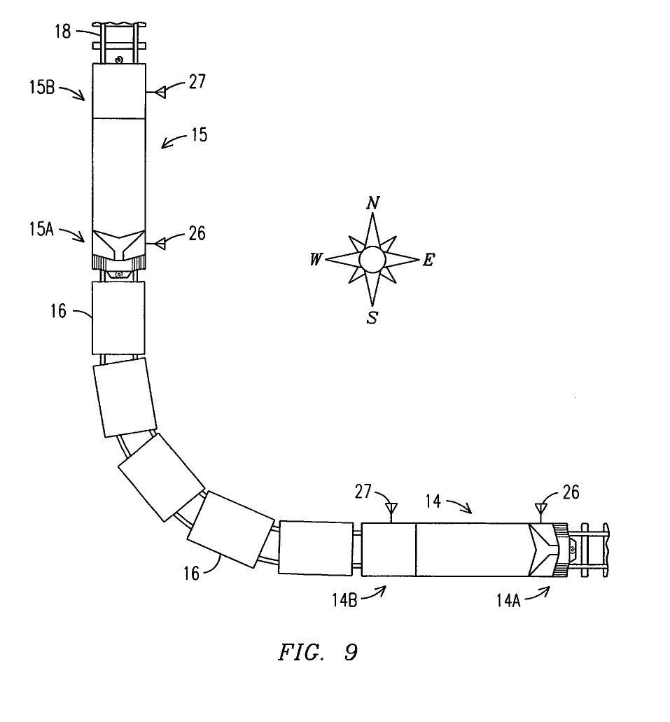

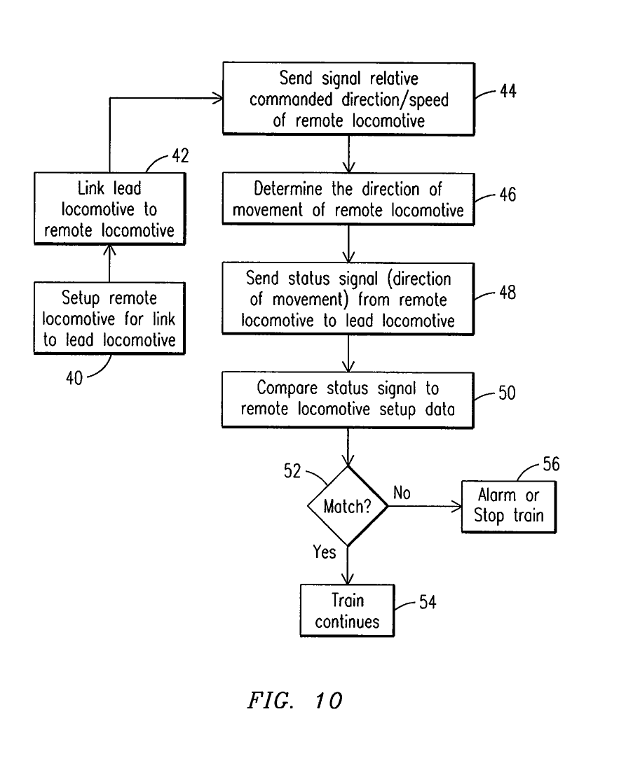

With respect to FIGS. 8 and 9 a second embodiment of the invention incorporates global positioning satellite systems (GPS) to determine the direction of movement of the locomotives 14 and 15. Each of the locomotives 14, 15 include two GPS receivers. There is a short hood receiver 26 and a long hood receiver 27 for the lead locomotive 14 and the remote locomotive 15. The present embodiment uses a differential in coordinates between the short hood receiver 26 and the long hood receiver 27 to determine in which direction the lead and remote locomotives are facing or moving.

In some instances when the train 13 is on a straight track 18 the verification of the power distribution system setup may be done before the train 13 begins moving on the track 18. More specifically, in reference to FIG. 8, the lead locomotive 14 is facing west. The short hood receiver 26 and long hood receiver 27 send one or more signals to the controller 24, which signals are indicative of coordinates of the each receiver 26, 27. The controller 24 is able to determine that the short hood receiver 26 is positioned west of the long hood receiver 27, so the short hood forward 14A is facing west. In addition, the controller 24 on the remote locomotive 15 determines the direction in which the remote locomotive 15 is facing. In this example, the controller 24 determines that the short hood 15A or receiver 26 is positioned west of the long hood 15B, so the short hood 15 is facing west. An operator has set up the remote locomotive 15 as SAME; therefore, the signal 22 sent from the remote locomotive 15 indicates that the short hood 15A of the remote locomotive 15 is facing west, and is set up as SAME. Upon receipt of the signal 22, the lead locomotive 14 (or controller 24 on the lead 14) verifies that the remote locomotive 15 has been properly set up by verifying that the short hood 15A of remote locomotive 15 is positioned west of the long hood 15B, and it should be setup SAME, which it is.

The above-described system and method may work if the train 13 is positioned on a straight track; however, in most cases, given the train 13 may be one or two miles long, the train 13 may have several curves or turns. For example, in reference to FIG. 9, the train 13 is positioned on a track 18 having a turn so the lead locomotive 14 is positioned east/west on the track 18, and the remote locomotive 15 is positioned north/south on the track 18, with the short hood 15A south of the long hood 15B. An operator (not shown) has set up the remote locomotive incorrectly by entering setup data for OPPOSITE.

When the train 13 begins to move one or more signals from receivers 26 and 27 on the remote locomotive 15 are transmitted to the controller 24 indicative of the changing coordinates of the receivers 26, 27. Since the receiver 26 and 27 indicate to the controller 24 that the short hood of the remote locomotive 15 is south of the long hood of the remote locomotive 15 and since the controller 24 can also determine that the locomotive is moving in a southward direction, the controller 24 can determine that the remote locomotive 15 is moving in a short hood forward direction. Alternatively, the coordinate data may be sent to controller 24 on the lead locomotive 14, which determines the short hood 15B is moving southward and therefore in a short hood forward direction. In either case, the data relative to the direction of movement indicating short hood forward movement is compared to the setup data—OPPOSITE, which is incorrect. An alarm is as to inform the operator on the lead locomotive 14 and train 13 such that he can take the appropriate action as determined by railroad operating rules or such that the train can be automatically stopped.

With respect to FIG. 10 there is illustrated a flow diagram listing steps to the method of verifying that a power distribution system for a locomotive has been properly set up. In step 40 one or more remote locomotives are set up for linking to the lead locomotive. As described above, an operator boards the remote locomotive and enters data relative to the direction the remote unit is facing and/or the direction of travel of the remote unit relative to the lead locomotive. The data input may include the lead locomotive rail numbers and a designation of “SAME” if the remote locomotive 15 is facing in the same direction of the lead locomotive 15, or “OPPOSITE” if the remote locomotive 15 is facing in a direction to that of the lead locomotive unit 14. In step 42, the lead locomotive 14 is linked to the remote locomotives 15 via the power distribution control system. In step 44, the lead locomotive 14 sends and signal indicative of the commanded direction of movement of the lead locomotive.

Direction of movement of the remote locomotive 15 is detected or determined in step 46. As described above, onboard sensors may be used to detect or predict a rotational direction of the wheels on a locomotive and/or the direction of movement of a locomotive. Alternatively, GPS receivers mounted on the short hood and long hood of the locomotives may be used to determine the direction of movement of the remote locomotive. In step 48, the remote locomotive 15 sends a signal to the lead locomotive 14, which signal is indicative of the direction of movement of the remote locomotive 15 and its setup (SAME or OPPOSITE) relative to the lead locomotive 15. Then, in step 50 the status of the lead locomotive (or the direction of movement of the lead locomotive 14) is compared to the status of the remote locomotive 15 (its direction of movement) and the remote locomotive's 15 setup data. If the direction of movement of the lead locomotive matches the remote setup data and status information the train continues as represented in steps 52 and 54. If there is not a match an alarm is generated so that the operator can take appropriate action or the trains is stopped as represented in steps 52 and 56.

While the preferred embodiments of the present invention have been shown and described herein, it will be obvious that such embodiments are provided by way of example only and not of limitation. Numerous variations, changes and substitutions will occur to those skilled in the art without departing from the teaching of the present invention. Accordingly, it is intended that the invention be interpreted within the full spirit and scope of the appended claims.

What is claimed is:

1. A system for verifying the set up of a distributed power control system having a lead locomotive, one or more remote locomotives and a plurality of railcars, and the distributed power control system having a communication system between the lead locomotive and the remote locomotive for a train, the system comprising:
an input command mechanism for the distributed power control system for entering setup data indicative of a direction the remote locomotive is facing relative to the lead locomotive;
at least one controller, linked to the communication system, for determining the direction of movement of the lead locomotive and the remote locomotive;
wherein the communications system provides a status signal from the remote locomotive to the lead locomotive indicative of the direction of movement of the remote locomotive and the signal including the setup data; and
wherein the controller compares data relative to the direction of movement of the lead locomotive to data relative to the direction of movement of the remote locomotive and to the remote locomotive setup data to verify whether the setup data has been properly entered.

2. The system of claim 1 further comprising one or more sensors on the lead locomotive and the remote locomotive for transmitting one or more signals to the controller indicative of the direction of movement of the lead locomotive and the remote locomotive.

3. The system of claim 1 wherein the communications system provides a signal from the lead locomotive to the remote locomotive indicative of the commanded direction of movement of the lead locomotive.

4. The system of claim 1 further comprising a command to stop the train is generated when the controller determines that the remote locomotive is moving in a direction that is not consistent with the setup data entered.

5. The system of claim 1 wherein the lead locomotive is positioned on a track short hood forward or long hood forward relative to the train and the setup data for the remote locomotive is entered as SAME or OPPOSITE.

6. The system of claim 1 wherein a global positioning satellite system is linked to the controller to determine the direction of movement of the lead locomotive and the remote locomotive.

7. The system of claim 6 further comprising a first GPS receiver associated with a short hood of the remote locomotive and a second GPS receiver associated with the long hood of the remote locomotive for providing coordinates of the short hood relative to the long hood of the remote locomotive.

8. The system of claim 7 further comprising a third GPS receiver associated with a short hood of the lead locomotive and a fourth GPS receiver associated with the long hood of the lead locomotive for identifying coordinates of the short hood relative to coordinates of the long hood of the lead locomotive.

9. The system of claim 1 wherein the data relative to the direction of movement of the locomotive comprises data relative to the direction of rotation of one or more axles on the locomotive.

10. The system of claim 1 wherein the data relative to the direction of movement of the locomotive is plugging information relating to the direction of rotation of traction motors.

11. The system of claim 1 wherein the data relative to the direction of movement of the locomotive is information relating to the magnitude and direction of traction motor power flow.

12. The system of claim 1 wherein the data relative to the direction of movement of the locomotive comprises information relating to wheel to rail adhesion.

13. The system of claim 1 wherein the data relative to the direction of movement of the locomotive comprises the application of sand to the railroad track between the short hood and the long hood of a locomotive.

14. The system of claim 1 wherein the data relative to the direction of movement of the locomotive comprises data relative to the geographical coordinates of a locomotive obtained by one or more global positioning satellite systems and data relative to a railroad track profile database.

15. A method for verifying the set up of a distributed power control system for a train having a lead locomotive, one or more remote locomotives and a plurality of railcars, and the distributed power control system having a communication system between the lead locomotive and the remote locomotive, the system comprising:
inputting in the distributed power control system setup data indicative of a direction the remote locomotive is facing relative to the direction the lead locomotive is facing;
determining the direction of movement of the lead locomotive and the remote locomotive;
transmitting a status signal, via the communications system, from the remote locomotive to the lead locomotive indicative of the direction of movement of the remote locomotive and including the setup data; and
comparing data relative to the direction of movement of the lead locomotive to data relative to the direction of movement of the remote locomotive and to the remote locomotive setup data to verify whether the setup data has been properly entered.

16. The method of claim 15 further comprising transmitting a status signal from the lead locomotive to the remote locomotive the status signal indicative of the commanded direction of movement of lead locomotive to the remote.

17. The method of claim 15 further comprising transmitting a signal to stop the train when a controller determines that the remote locomotive is moving in a direction that is not consistent with the setup data entered.

18. The method of claim 15 wherein the step of determining the direction of movement of the lead and remote locomotives includes detecting the rotational direction of the wheels wherein the wheels rotate in a first direction indicative of a short hood forward direction and the wheels rotate in a second direction associated with a long hood forward direction.

19. The method of claim 15 wherein the step of determining the direction of movement of the lead locomotive includes determining the geographic coordinates of a short hood of the lead locomotive relative to a long hood of the lead locomotive.

20. A computer program for verifying the set up of a distributed power control system for a train having a lead locomotive, one or more remote locomotives and a plurality of railcars, and the distributed power control system having a communication system between the lead locomotive and the remote locomotive, the system comprising:
a computer module for inputting in the distributed power control system setup data indicative of a direction the remote locomotive is facing relative to the direction the lead locomotive is facing;
a computer module for determining the direction of movement of the lead locomotive and the remote locomotive;
a computer module for transmitting a status signal, via the communications system, from the remote locomotive to the lead locomotive indicative of the direction of movement of the remote locomotive and including the setup data; and
a computer module for comparing data relative to the direction of movement of the lead locomotive to data relative to the direction of movement of the remote locomotive and to the remote locomotive setup data to verify whether the setup data has been properly entered.

21. The computer program of claim 20 further comprising a computer module for transmitting a signal from the lead locomotive to the remote locomotive, the signal indicative of the commanded direction of movement of lead locomotive to the remote.

22. The computer program of claim 20 further comprising a computer module for transmitting a command to stop the train when a controller determines that the remote locomotive is moving in a direction that is not consistent with the setup data entered.

23. The computer program of claim 20 wherein the computer module for determining the direction of movement of the lead and remote locomotives includes a computer module for detecting the rotational direction of the wheels wherein the wheels rotate in a first direction indicative of a short hood forward direction and the wheels rotate in a second direction associated with a long hood forward direction.

24. The computer program of claim 23 wherein the computer module for determining the direction of movement of the lead locomotive includes a computer module for determining the geographic coordinates of a short hood of the remote locomotive relative to a long hood of the remote locomotive.

25. The computer program of claim 24 wherein the computer module for determining the direction of movement of the lead locomotive includes a computer module for determining the geographic coordinates of a short hood of the lead locomotive relative to a long hood of the lead locomotive.
